(19) United States
(12) Patent Application Publication
(10) Pub. No.: US 2026/0146828 A1
(43) Pub. Date: May 28, 2026

(54) Archery Bow Accessory Mounting Structures

(71) Applicant: Yusong Zhou, Arcadia, CA (US)

(72) Inventor: Yusong Zhou, Arcadia, CA (US)

(21) Appl. No.: 19/400,798

(22) Filed: Nov. 25, 2025

Related U.S. Application Data
(60) Provisional application No. 63/725,989, filed on Nov. 27, 2024.

(51) Int. Cl. F41G 1/467; F16M 11/14

(52) U.S. Cl. CPC F41G 1/467; F16M 11/14

(57) ABSTRACT

Disclosed are improved bow sight mounting structures that attach a bow sight to an archery bow. The bow mounting structures each unifies and simplifies adjustment of a bow sight or other accessory about three orthogonal axes of rotation. Each of the disclosed bow sight mounting structures utilize a ball and socket joint to mount the bow sight to the bow. The ball and socket joint has a first component attached to the bow and a second component attached to the bow sight. The ball and socket joint enables optical alignment of the bow sight with respect to the bow about three orthogonal axes of rotation.

### RELATED APPLICATION

This application claims priority to and the benefit of the filing date of my U.S. provisional patent application Ser. No. 63/725,989 “Archery Bow Accessory Mounting Structures” filed Nov. 27, 2024 at Attorney Docket No. 1-3481-P and pending on the filing date of this application.

### FIELD OF THE DISCLOSURE

This disclosure relates to implements such as archery bows, and in particular structures for mounting accessories to an implement such as an archery bow.

### BACKGROUND OF THE DISCLOSURE

Archers such as bowhunters, 3D shooters, and target shooters use archery bows to shoot arrows at a target. The archer typically uses a bow sight mounted to the bow that assists the archer in accurately aiming the arrow at the target.

Bows may be provided or used with structures that mount a bow sight to the side or front of the bow riser. The front of the bow faces the archer and the back of the bow faces the target when aiming the bow with the bow sight. The riser is the central portion of the bow containing the grip and is used in mounting accessories to a bow (typically using standardized mounting configurations).

FIG. 83 illustrates the riser 10 being provided with a pair of threaded sight mounting holes 12, 14 in a standardized arrangement. The mounting holes 12, 14 fasten a bracket (not shown) to the side of the riser that carries the bow sight.

FIG. 84 is a back view of the riser 10. Fastened to the back of the riser 10 is a bow sight mounting structure 16 having a standardized configuration. The mounting structure 16 fastens a bracket or a mounting rail to the back of the riser that carries the bow sight. The illustrated bow sight mounting structure 16 is, as a non-limiting example, a Picatinny rail. Other mounting structures (Weaver rails, dovetail mounts, and other rail systems) that can mount a compatible bow sight mounting structure to the back of the riser may also be used as the mounting structure 16. Adapters are commercially available that enable bow sight mounting structures designed to be mounted to the side of the riser to be mounted to the back of the riser and enable bow sight mounting structures designed to be mounted to the back of the riser to be attached to the side of the riser.

FIGS. 85-87 illustrate a bow sight 18 attached to the riser 10 by an extension bar 20 (to simplify the drawings, the structure attaching the extension bar 20 to the riser 10 is not shown). The bow sight 18 is a non-telescopic bow sight and is only illustrative of an accessory that can be attached to the extension bar or archery bow in accordance with this disclosure. The extension bar 20 is fastened to the side or back of the riser 10 as previously described. The extension bar 20 spaces the bow sight 18 a fixed distance away from the back of the bow. Some extension bar designs enable the archer to selectively adjust and set the bow sight distance from the riser.

The bow sight 18 must be properly optically aligned with the bow for highly accurate shooting. The illustrated bow sight 18 includes a bubble level 22 that provides feedback to the archer that the bow and bow sight are properly aligned at release. Aligning the bow sight 18 with the bow requires alignment of the bow sight about three orthogonal axes of rotation.

The three axes of rotation are commonly referred to as the first axis, second axis, and third axis. FIGS. 88-90 illustrate the first axis of rotation 24, the second axis of rotation 26, and the third axis of rotation 28 with respect to the bow sight 18. The first axis of rotation is a horizontal line extending left to right with respect to the archer that is parallel with the horizontal ground plane 30. The second axis of rotation is a horizontal line parallel with the ground plane that extends along parallel with the line of sight through the bow sight. The third axis of rotation is a vertical line with respect to the ground plane. As shown in FIG. 91, the third axis is parallel with the plane 32 that an arrow would ideally travel with no wind from the bow to the target. Manufacturer directions for adjusting the axes of rotation of a bow sight for aiming are provided with the bow sight and are also readily available via the internet.

Modern bow sight mounting structures allow adjustment of the bow sight with respect to the bow about all three axes. The individual first, second, and third axes 24, 26, 28 are spaced apart from one another with respect to the mounting structure. Adjustment for each axis uses an external level that confirms the bow sight level 22 is centered when the external level is also centered with respect to the axis.

Typical mounting structures have respective pairs of screws associated with each axis. The pairs of screws are located at different locations of the mounting structure. Loosening the screws associated with an axis allows rotation of the sight about that axis. Each axis must be individually adjusted in the proper order.

There is a need for an improved bow sight mounting structure that unifies and simplifies adjustment of a bow sight or other accessory about the three axes of rotation.

### BRIEF SUMMARY OF THE DISCLOSURE

Disclosed are improved bow sight mounting structures that each unifies and simplifies adjustment of a bow sight or other accessory about three orthogonal axes of rotation.

Each of the bow sight mounting structures in accordance with this disclosure utilize a ball and socket joint to mount the bow sight to the bow. The ball and socket joint has a first component attached to the bow and a second component attached to the bow sight to attach the bow sight to the bow.

A ball and socket joint is a joint that enables rotation of the “ball” component of the joint in all directions around a center point with respect to the “socket” component of the joint. The ball has an outer bearing surface defining at least a portion of a sphere. The socket has an inner bearing surface defining at least a portion of a sphere. The bearing surfaces closely conform with one another where they face one another and bear against one another to enable relative rotation of the ball with respect to the socket about the center of the spherical bearing surfaces. It is not necessary that the entirety of one bearing surface face the other bearing surface; one bearing surface may extend beyond the other bearing surface in some or all relative positions of the ball with respect to the socket.

In accordance with a possible embodiment in accordance with this disclosure, the ball and socket joint attaches a bow sight to an archery bow. One of the ball and socket of the ball and socket joint is configured to be attached directly or indirectly to the bow and the other of the ball and socket of the ball and socket joint is configured to be attached directly or indirectly to the bow sight. The ball or socket of the ball and socket joint intended to be attached to the bow will be referred to a the “bow component” herein. The other of the ball or socket of the ball and socket intended to be attached to the bow sight will be referred to as the “bow sight component” herein.

The inventor is the first to recognize that a ball and socket joint provides a readily adjustable mounting structure that unifies and simplifies optical alignment of a bow sight with respect to the bow about the three axes of rotation.

It is understood that use of the terms “bow component” or “bow sight component” when used alone refers to a component of the ball and socket joint of embodiments of accessory mounting structures in accordance with this disclosure. More broadly, a “bow component” is connected to the implement (as a non-limiting example, an archery bow) and a “bow sight component” is attached to the implement accessory (as a non-limiting example of an accessory, a bow sight). As described in more detail below, the ball and socket joint enables relative selective angular displacement of the implement accessory with respect to the implement.

In possible first embodiments of the disclosed mounting structure, the ball and socket joint is fixedly attached directly to the bow riser. The bow component is fastened to the riser, typically using the side threaded mounting holes or the rail attached to the back side of the riser. The bow sight component is typically configured to carry an extension bar or other structural mounting component that attaches the bow sight. The bow sight component can displace angularly with respect to the bow component, enabling angular alignment of a bow sight attached to the bow sight component about three orthogonal axes of rotation.

In a variant first embodiment, the ball and socket joint is attached to the bow and the bow sight component functions as the bow sight mounting structure that directly or indirectly attaches a bow sight to the bow.

In these first embodiments the ball and socket joint is intended to normally remain attached to the bow even when the bow sight is removed from the bow. The bow sight component may be configured to present mounting holes, a Picatinny rail, or other conventional bow sight mounting structure that in turn is used to connect the bow sight to the bow sight component. The ball and socket joint enables adjusting optical alignment of the bow sight with respect to the bow about all three alignment axes using conventional mounting structures that do not otherwise offer optical adjustment or only offer adjustments about less than all three alignment axes of rotation.

In possible second embodiments of the disclosed mounting structure, the bow component is attached to the riser. The bow sight component is attached to an end of the extension bar or other structural mounting component that carries the bow sight. In this embodiment the bow component is intended to remain attached to the bow even when the bow sight and bow sight component are removed from the bow. The bow component functions as the mounting structure fixed to the bow and the bow sight component is configured to be removably attachable to the bow component.

In possible third embodiments of the disclosed bow sight mounting structure, the ball and socket joint forms part of or is attached to an extension bar that attaches the bow sight to the bow. The bow sight mounting structure includes fastening structure that attaches the extension bar to the bow in a conventional manner. The bow sight mounting structure may space the ball and socket joint a fixed, predetermined distance from the bow or may enable the archer to selectively adjust the distance between the ball and socket joint and the bow.

In possible fourth embodiments of the disclosed bow sight mounting structure, the extension bar includes conventional fastening structure at one end of the bar and a bow sight component at the other end of the extension bar. A bow sight is attached to a bow sight component.

In possible fifth embodiments of the disclosed bow sight mounting structure, the bow sight includes the ball and socket joint. The bow sight includes conventional fastening structure that attaches the bow sight to the riser or to an extension bar, and the ball and socket joint is located between the conventional fastening structure and the portion of the bow sight viewed through by the archer.

Yet other embodiments of the disclosed bow sight mounting structure incorporating a ball and socket joint that enables optical adjustment of the bow sight with respect to the bow about the three axes of rotation can be adapted to other conventional bow sight mounting structures.

Other objects and features of the disclosure will become apparent as the description proceeds, especially when taken in conjunction with the accompanying drawing sheets illustrating one or more illustrative embodiments.

### BRIEF DESCRIPTION OF THE DRAWINGS

FIG. 1 is a representation of a ball and socket joint and three orthogonal axes of rotation provided by the ball and socket joint for optical alignment of a bow sight attached to the bow sight component of the ball and socket joint.

FIG. 2 is a perspective view of a first embodiment ball and socket joint.

FIG. 3 is an exploded view of the ball and socket joint shown in FIG. 2.

FIGS. 4-6 are front, top, and left side views respectively of the ball and socket joint shown in FIG. 2.

FIG. 7 is a sectional view taken along line 7-7 of FIG. 5.

FIG. 8 is a perspective view of a second embodiment ball and socket joint.

FIG. 9 is an exploded view of the ball and socket joint shown in FIG. 8.

FIGS. 10-13 are front, right side, left side, and top views respectively of the ball and socket joint shown in FIG. 8.

FIG. 14 is a sectional view taken along line 14-14 of FIG. 13.

FIG. 15 is a perspective view of a third embodiment ball and socket joint.

FIG. 16 is an exploded view of the ball and socket joint shown in FIG. 15.

FIGS. 17-19 are right side, back, and front side views respectively of the ball and socket joint shown in FIG. 15.

FIG. 20 is a sectional view taken along line 20-20 of FIG. 17.

FIG. 21 is a perspective view of a fourth embodiment ball and socket joint.

FIG. 22 is an exploded view of the ball and socket joint shown in FIG. 21.

FIGS. 23-26 are left side, back, and front views respectively of the ball and socket joint shown in FIG. 21.

FIG. 27 is a perspective view of a fifth embodiment ball and socket joint.

FIG. 28 is an exploded view of the ball and socket joint shown in FIG. 27.

FIGS. 29-31 are right side, top, and front views respectively of the ball and socket joint shown in FIG. 27.

FIG. 32 is a sectional view taken along line 32-32 of FIG. 31.

FIG. 33 is a schematic side view of an embodiment of a bow sight mounting structure in accordance with this disclosure in which the ball and socket joint is attached directly to the bow.

FIG. 34 is a schematic side view of an embodiment of a bow sight mounting structure in accordance with this disclosure in which the bow component is attached to the bow and the bow sight component is attached to an end of an extension bar.

FIG. 35 is a schematic side view of an embodiment of a bow sight mounting structure in accordance with this disclosure in which the ball and socket joint is disposed in the extension bar intermediate of the opposite ends of the extension bar.

FIG. 36 is a schematic side view of an embodiment of a bow sight mounting structure in accordance with this disclosure in which the ball and socket joint is disposed on a free end of an extension bar, the extension bar being fastened to the bow.

FIG. 37 is a schematic top view of an embodiment of a bow sight mounting structure in accordance with this disclosure in which the ball and socket joint is included as a component part of the bow sight.

FIGS. 38 and 39 are respective front-side and back-side perspective views of a compound bow with a first embodiment of a bow sight mounting structure in accordance with this disclosure.

FIG. 40 is an exploded view of the bow sight mounting structure shown in FIG. 38.

FIG. 41 is a perspective view of the bow sight mounting structure shown in FIG. 38.

FIGS. 42-47 are respective bottom, left side, top, right side, back, and left side view of the bow sight mounting structure shown in FIG. 38.

FIG. 48 is a back-side perspective view of a second embodiment bow sight mounting structure in accordance with this disclosure.

FIG. 49 is an exploded view of the bow sight mounting structure shown in FIG. 48.

FIGS. 50-53 are respective front, right side, left side, and top views of the bow sight mounting structure shown in FIG. 48.

FIG. 54 is a back-side perspective view of a third embodiment bow sight mounting structure in accordance with this disclosure.

FIG. 55 is an exploded view of the bow sight mounting structure shown in FIG. 54.

FIGS. 56-61 are respective front, right side, left side, bottom, right side, and top views of the bow sight mounting structure shown in FIG. 54.

FIGS. 62 and 63 are respective right-side and left-side perspective views of the bow sight mounting structure shown in FIG. 48 carrying a bow sight attached to the bow sight component of the bow sight mounting structure.

FIGS. 64-69 are respective front, back, bottom, left side, right side, and top views of the bow sight mounting structure and attached bow sight shown in FIG. 62.

FIG. 70 is a sectional view taken along line 70-70 of FIG. 68.

FIG. 71 is a sectional view taken along line 71-71 of FIG. 69.

FIG. 72 is a sectional view taken along line 72-72 of FIG. 69.

FIGS. 73 and 74 are respective right-side and left-side perspective views of a fourth embodiment bow sight mounting structure in accordance with this disclosure carrying a bow sight attached to the bow sight component of the bow sight mounting structure.

FIGS. 75-79 are respective top, left side, right side, back, and front views of the bow sight mounting structure and attached bow sight shown in FIG. 73.

FIG. 80 is a sectional view taken along line 80-80 of FIG. 76.

FIG. 81 is a sectional view taken along line 81-81 of FIG. 75.

FIG. 82 is a sectional view taken along line 82-82 of FIG. 75.

FIG. 83 is a schematic side view of a portion of an archery bow riser.

FIG. 84 is a back view of the riser shown in FIG. 83.

FIG. 85 is a front view of the riser shown in FIG. 83 with a bow sight attached thereto.

FIG. 86 is a side view of the riser and attached bow sight shown in FIG. 85.

FIG. 87 is a top view of the riser and attached bow sight shown in FIG. 85.

FIG. 88 is a back view of a bow sight and the bow sight's first and third axes.

FIG. 89 is a side view of the bow sight and the bow sight's first and second axes.

FIG. 90 is a top view of the bow sight and the bow sight's second and third axes.

FIG. 91 is a side view of the bow sight illustrating the bow sight's third axis with respect to the ground plane.

### DETAILED DISCLOSURE

The accessory mounting structures of the present disclosure are illustrated as mounting a bow sight to a riser of an archery bow. The same accessory mounting structures can be used or modified to attach other types of sights, lights, lasers, or other accessories to an archery bow or other implement, and the teaching of this disclosure is not limited to mounting bow sights to archery bows.

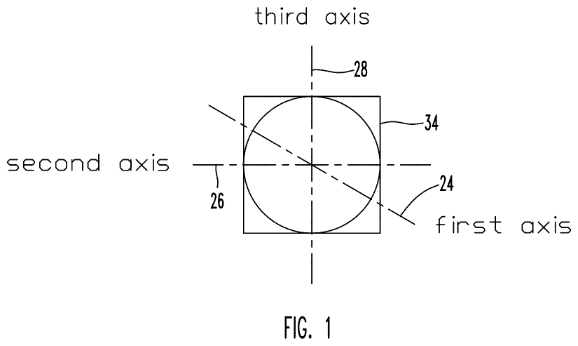

FIG. 1 is a representation of a ball and socket joint 34 and the bow sight first, second, and third axes of rotation 24, 26, 28. The ball and socket joint permits relative rotation of the bow sight component 36 with respect to the bow component 38 about the three axes of rotation to achieve proper optical alignment of the bow sight with the bow. The ball and socket joint 34 provides a sufficient angular range of motion of the bow sight component about each of the three axes of rotation to achieve optical alignment of the bow sight with the bow.

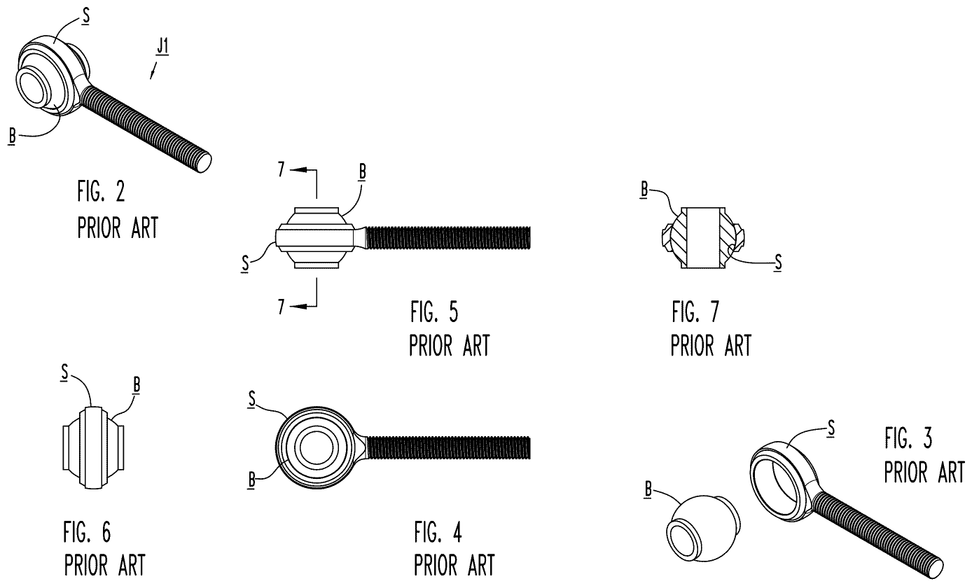

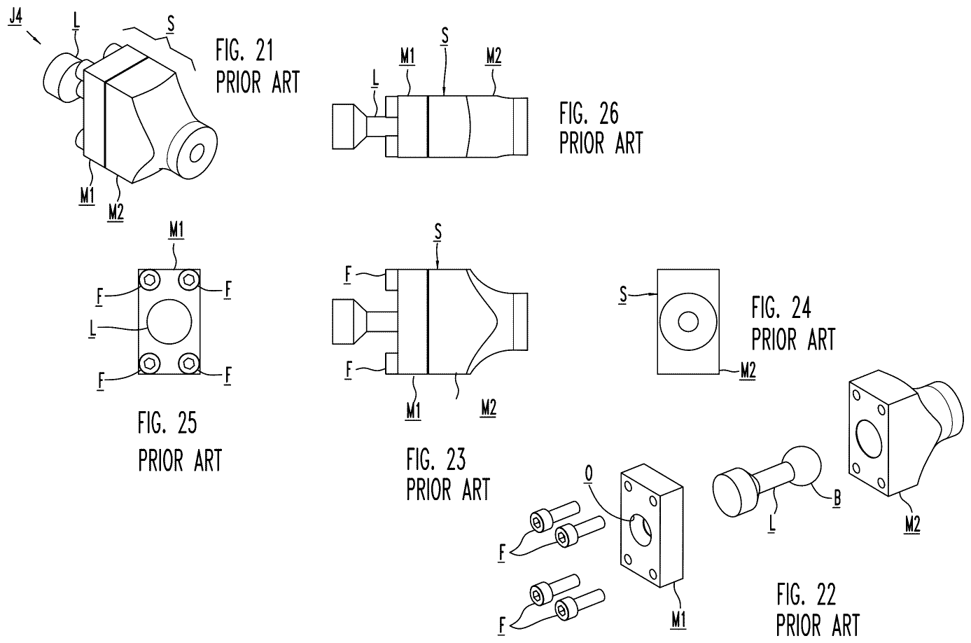

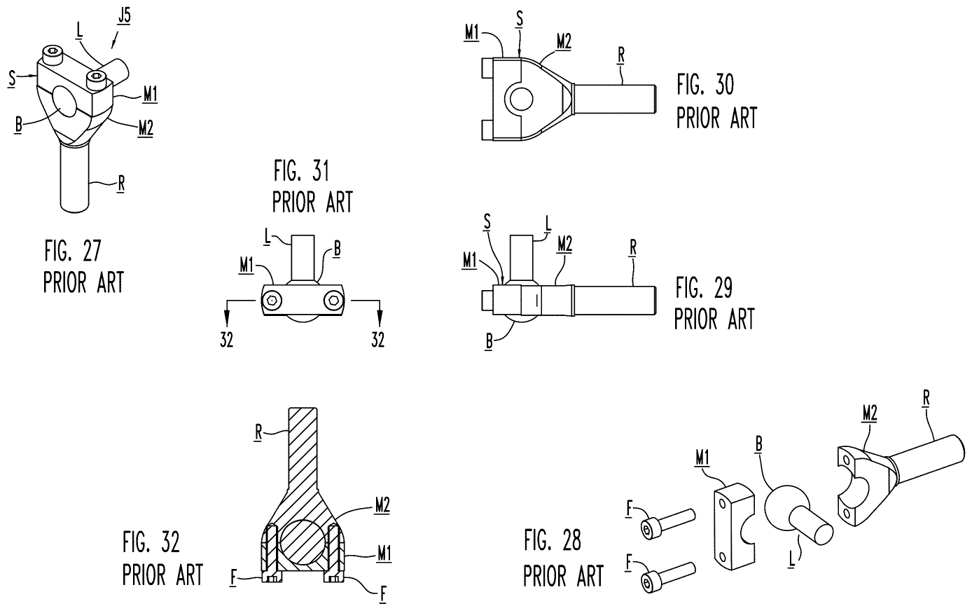

FIGS. 2-32 illustrate different non-limiting constructions of ball and socket joints that can be adapted for use in accessory mounting structures in accordance with this disclosure. Ball and socket joints are available commercially in a variety of sizes and design and material options, and so the ball and socket joints in the figures will not be described in great detail.

FIGS. 2-7 illustrate a ball and socket joint J1 in which the socket S is attached to a threaded rod R. The ball B has a through-hole H that can receive a fastener (not shown). The socket S extends like a ring about a diametral portion of the ball B. The through-hole H extends through the ring of the socket S.

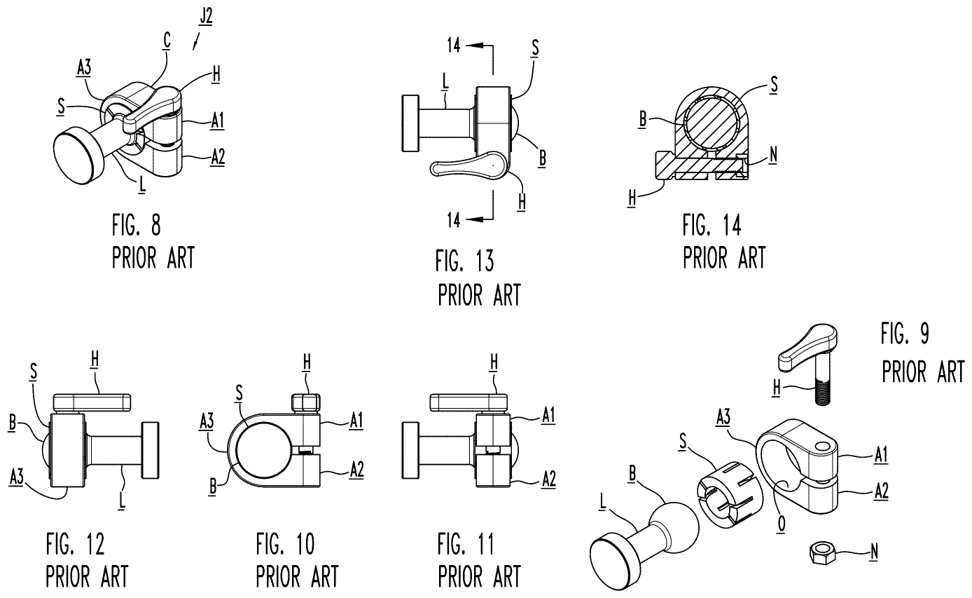

FIGS. 8-14 illustrate a ball and socket joint J2 that includes an integral, one-piece clamp C that surrounds and receives the socket S. The clamp C has a pair of arms A1, A2 that extend from opposite ends of a “C”-shaped arm connector portion A3. The connector portion A3 and the arms A1, A2 cooperate to form a through-opening O that receives the socket S. The clamp C includes a handled, threaded rod H that is received in a nut N non-rotatably held in the arm A2. The rod H and the nut N cooperate to urge the arms A1, A2 against the socket C sufficiently to fix the ball B relative to the socket S. The rod H and the nut N cooperate to enable the arms A1, A2 to move away from the ball B sufficiently to permit relative rotation between the ball B and the socket S. The illustrated ball and socket joint includes an elongate lever arm L extending radially away from the ball B. The lever arm L can be fixedly positioned or made pivotable relative to the socket S over a wide range of operating positions.

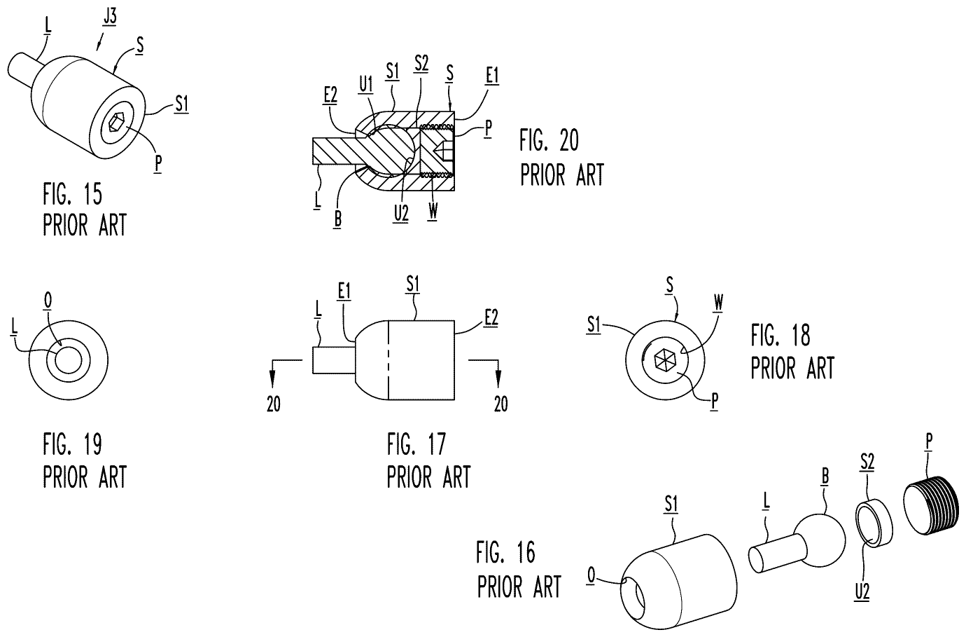

FIGS. 15-20 illustrate a ball and socket joint J3 in which the socket S is defined by a generally body S1 and a separate threaded insert S2. The body S1 has a threaded annular wall W that extends axially from an open first end E1 of the socket body S1 to an internal, generally spherical surface portion U1 adjacent to the axially opposite second end E2 of the socket body. The surface portion U1 conforms with the ball B. The insert S2 has an outer, generally spherical surface portion U2 that conforms with the ball B. The insert S2 is received in the annual wall W with the surface portion U2 facing the body surface portion U1. A plug P is threaded into the body S1 from the open end E1 and urges the insert surface U2 against the ball B. In turn the ball B is urged against the body surface U1. The plug P can be selectively positioned along the wall W to vary the force applied to the ball B, enabling the ball B to be fixed relative to the socket S or enabling rotation of the ball B relative to the socket S. A lever arm L extends radially from the ball B. The lever arm L extends from the ball B through an opening O formed in the socket body E2 and extends away from the socket S. The insert S2 can be removed from the body S1 for removing the ball B from the socket S.

FIGS. 21-26 illustrate a ball and socket joint J4 in which the ball B is held between two releasably fastenable members M1, M2. The members M1 and M2 cooperate to form the socket S that receives the ball B. The member M1 includes a through opening O that enables a lever arm L extending radially from the ball B to pass through M1 and extend away from the ball and socket joint. Fasteners F can be selectively tightened to fix the ball B with respect to the socket S or to enable the ball B to rotate relative to the socket S and position the angular position of the lever arm L.

FIGS. 27-32 illustrate a ball and socket joint J5 in which the ball B is held between two releasably fastenable members M1, M2 that form the socket S. The members M1 and M2 cooperate to form the socket S that receives the ball B. The socket is open on opposed sides, enabling a lever arm L extending from the ball B to extend out of the socket S and away from one side of the socket S. The member M2 includes an elongate rod R that extends along an axis to an free end of the rod R. The lever arm L can be positioned to extend axially perpendicular to the axis of the rod R or can be selectively positioned to extend generally transverse to the axis of the rod R.

Non-limiting examples of use of a ball and socket joint with embodiments of bow sight mounting structures in accordance with this disclosure are illustrated schematically in FIGS. 33-37.

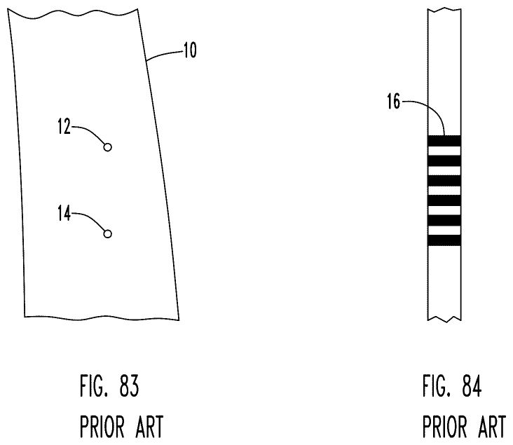

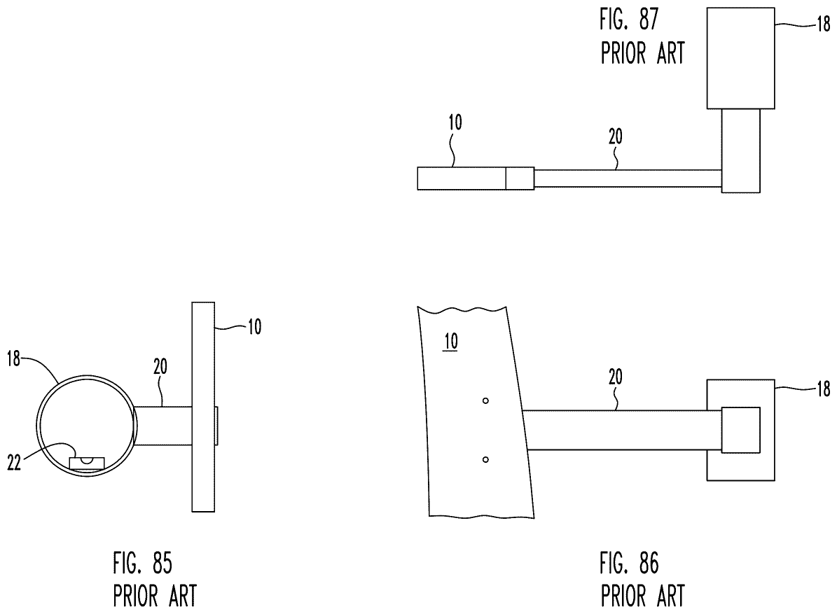

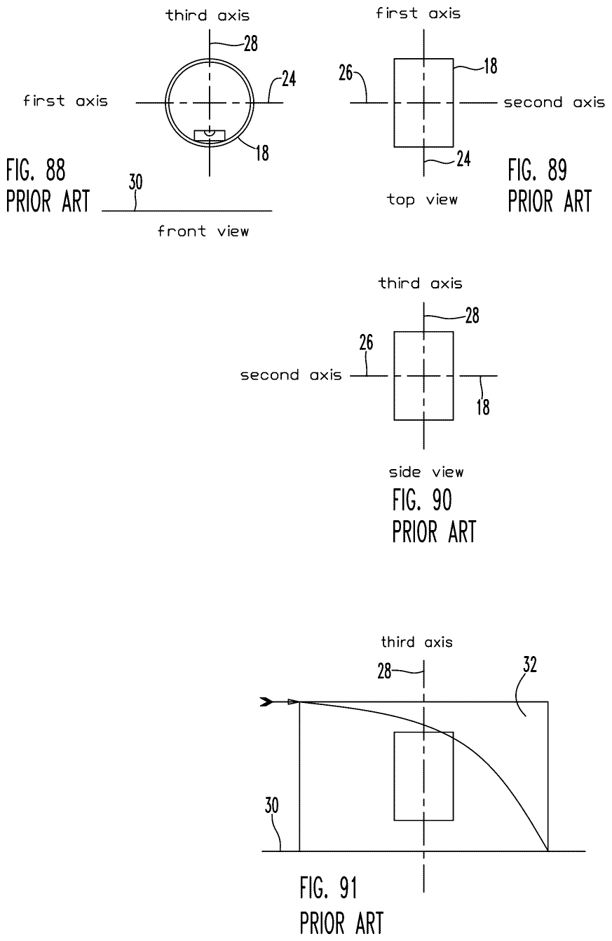

FIG. 33 is an embodiment of a bow sight mounting structure in which a ball and socket joint 34 is attached directly to the bow riser 10. The bow sight mounting structure serves the function of the conventional riser mounting structure 16 shown in FIG. 83 but the bow sight component 36 and the bow component 38 can be displaced relative to each other about the first, second, and third axes 24, 26, 28 respectively as shown in FIG. 1. The bow component 38 is fastened to the bow riser 10 by fasteners or may be formed as an integral portion of the bow itself. The exposed end of the bow sight component 36 is configured as a Picatinny rail to mount a conventional extension bar that can carry the bow sight. The exposed end of the bow sight component 36 in other possible embodiments may be configured using other conventional means for attaching an extension bar or a mounting bracket to a bow riser.

FIG. 34 is an embodiment of a bow sight mounting structure in accordance with this disclosure in which a ball and socket joint 34 has the bow component 38 attached to the bow riser 10 and the bow sight component 36 is attached to an end of an extension bar 20. The bow component 38 is fastened directly to the riser 10.

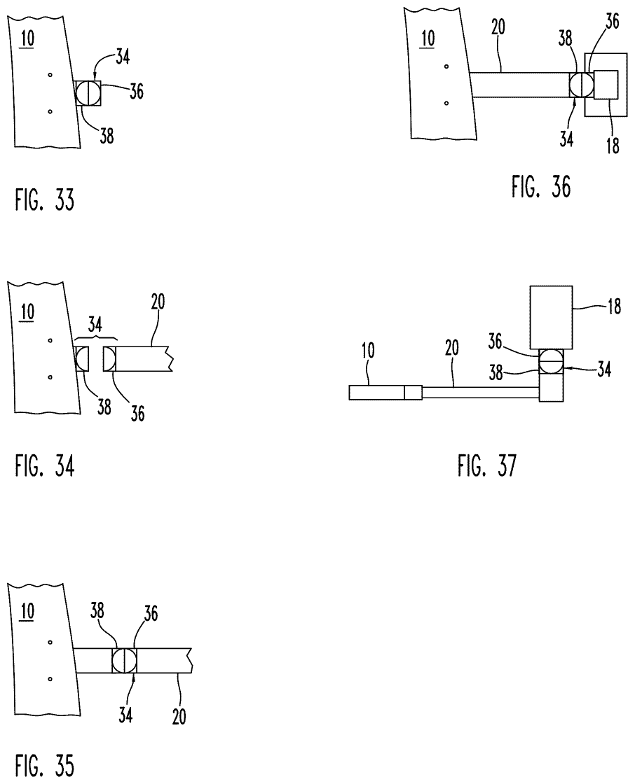

FIG. 35 is an embodiment of a bow sight mounting structure in accordance with this disclosure in which the ball and socket joint 34 is disposed in the extension bar 20 intermediate of the ends of the extension bar. The ends of the extension bar are configured in a conventional manner for fastening the extension bar to the bow riser 10 and for attaching a bow sight to the extension bar. The bow sight component 36 is attached to the portion of the extension bar 20 that carries the bow sight. The bow component 38 is attached to the portion of the extension bar 20 that is attached to the riser 10.

FIG. 36 is an embodiment of a bow sight mounting structure in accordance with this disclosure in which one end of an extension bar 20 is attached to the riser 10 and the socket joint 34 is disposed on the opposite second end of the extension bar 20 not attached to the bow riser 10. The bow sight component 36 is configured to mount a bow sight to the bow sight component.

FIG. 37 is an embodiment of a bow sight mounting structure in accordance with this disclosure in which the ball and socket joint 34 (that includes the bow sight component 36 and the bow component 38) is included as a component of the bow sight 18. The bow component 38 attaches to an extension bar 20. In other embodiments the bow component 38 is configured to be attached directly to the bow (similar to the attachment of the bow component 38 to the riser 10 shown in FIG. 33).

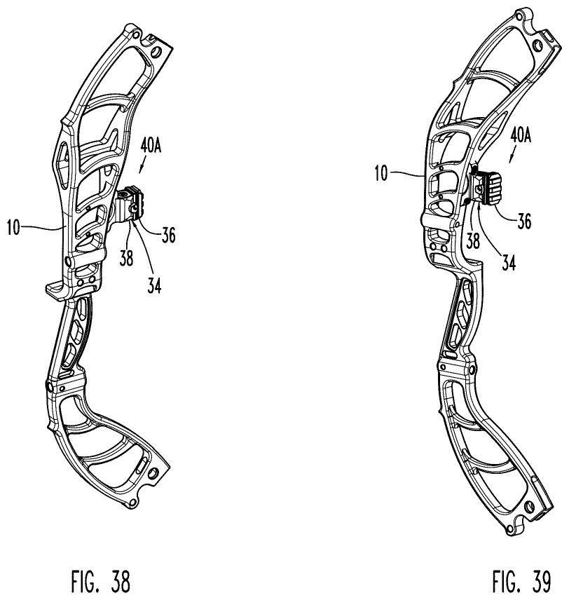

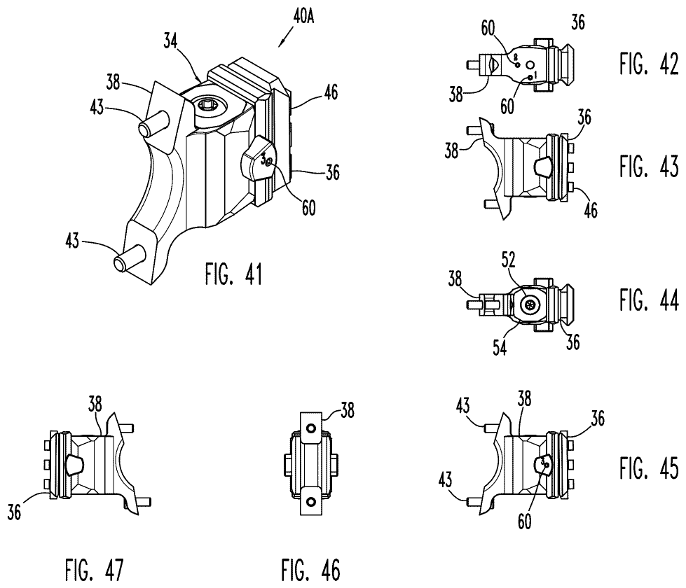

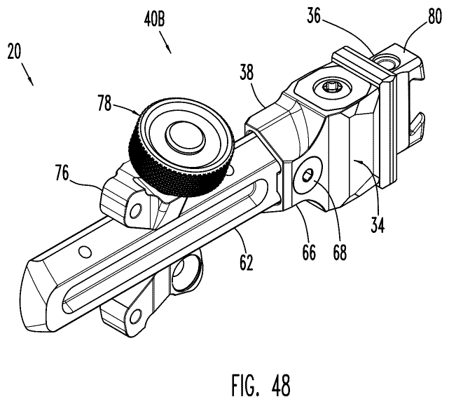

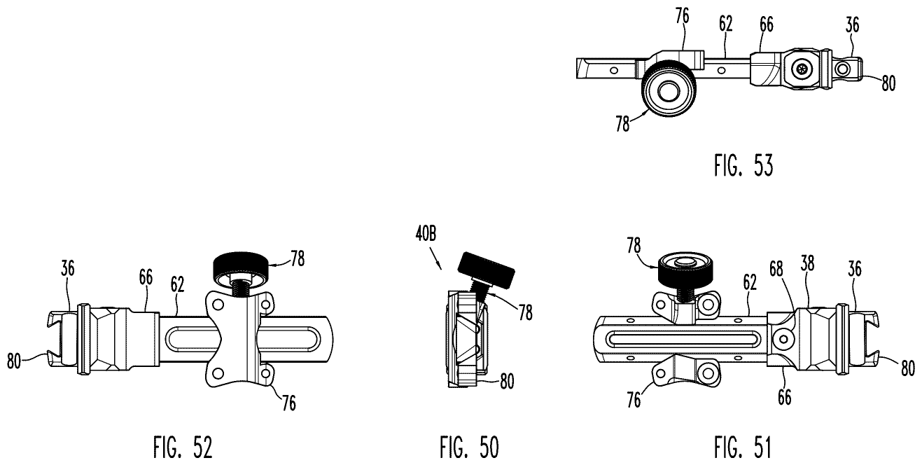

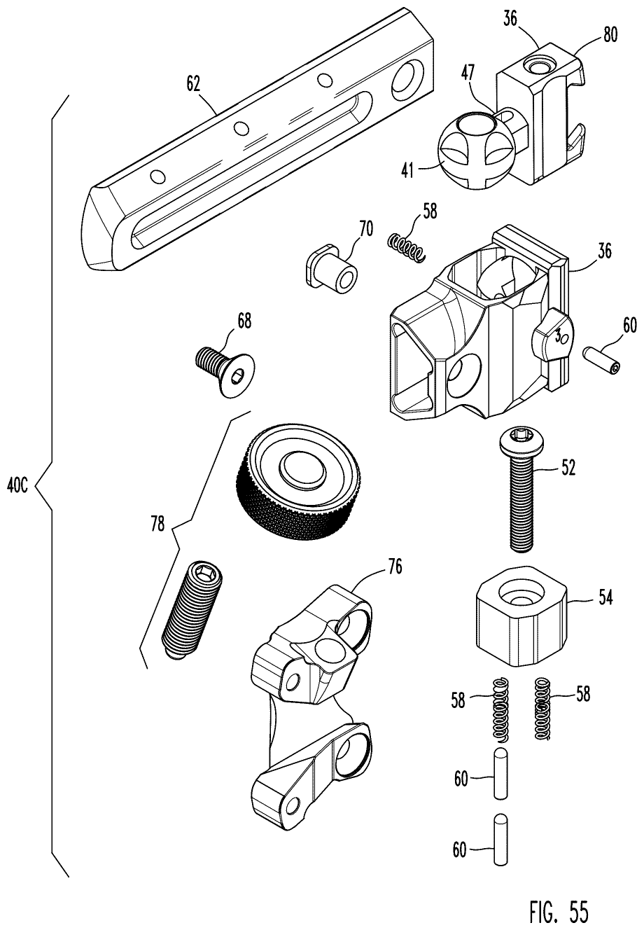

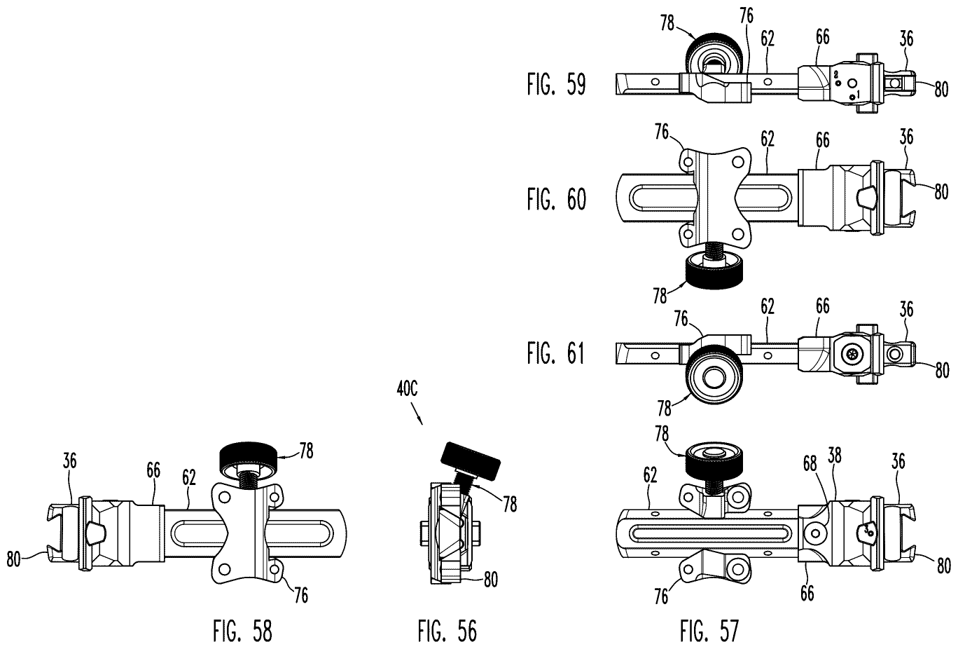

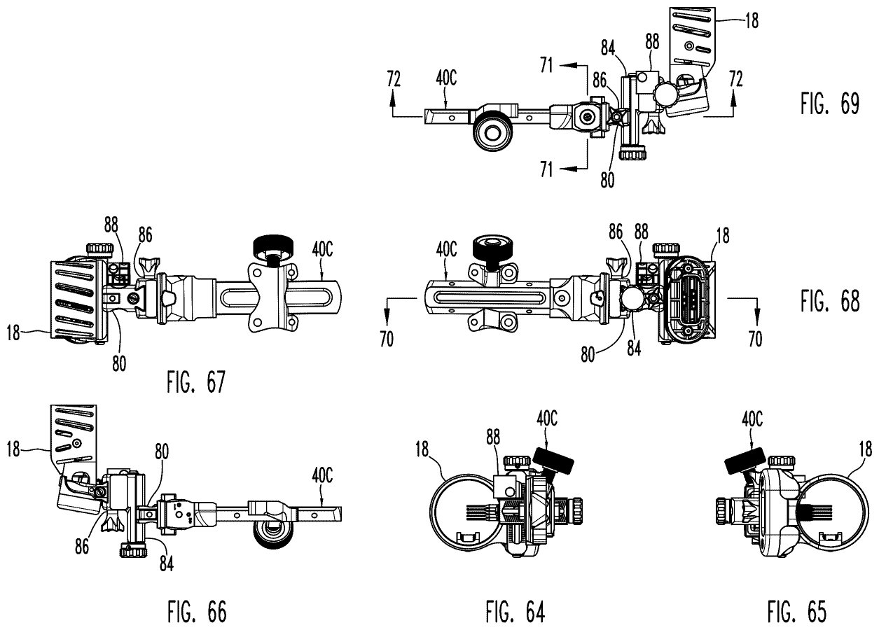

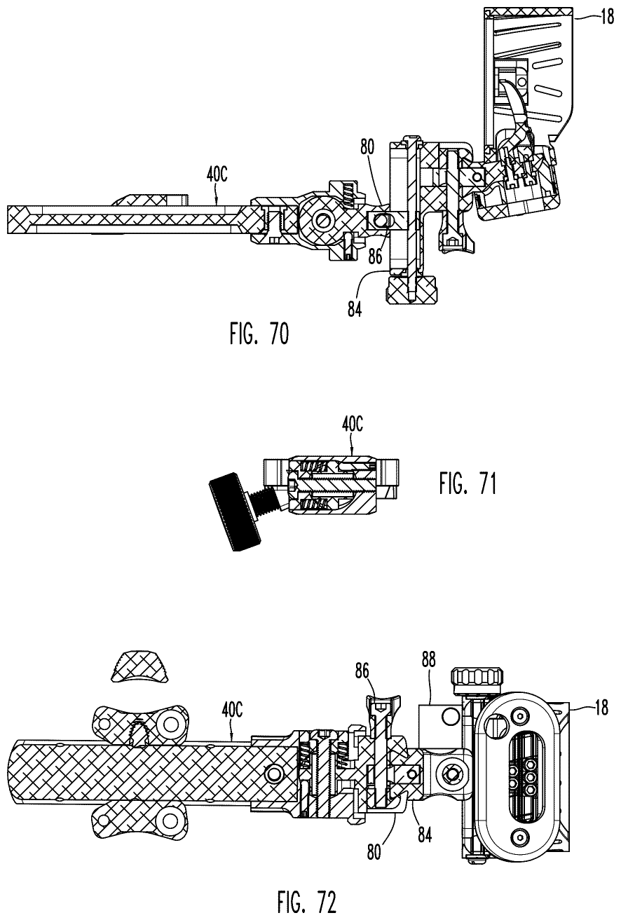

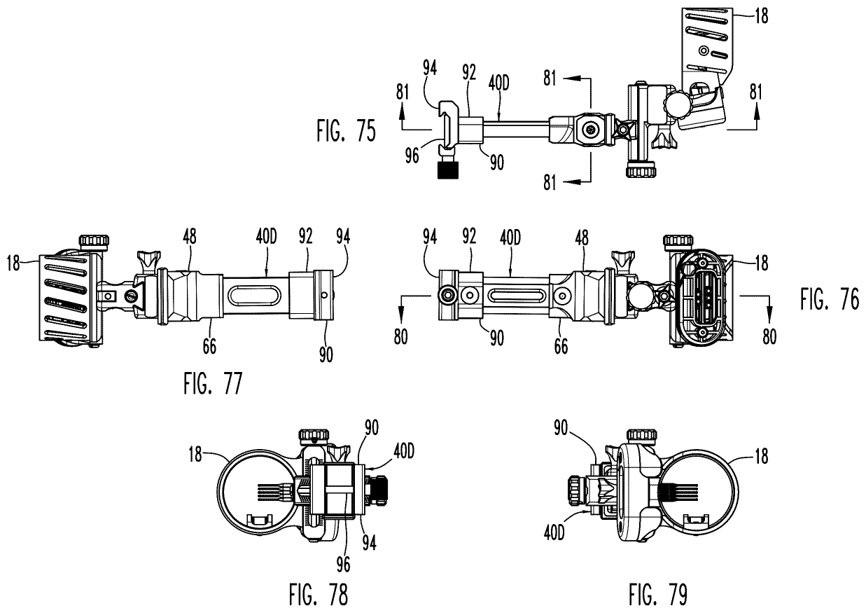

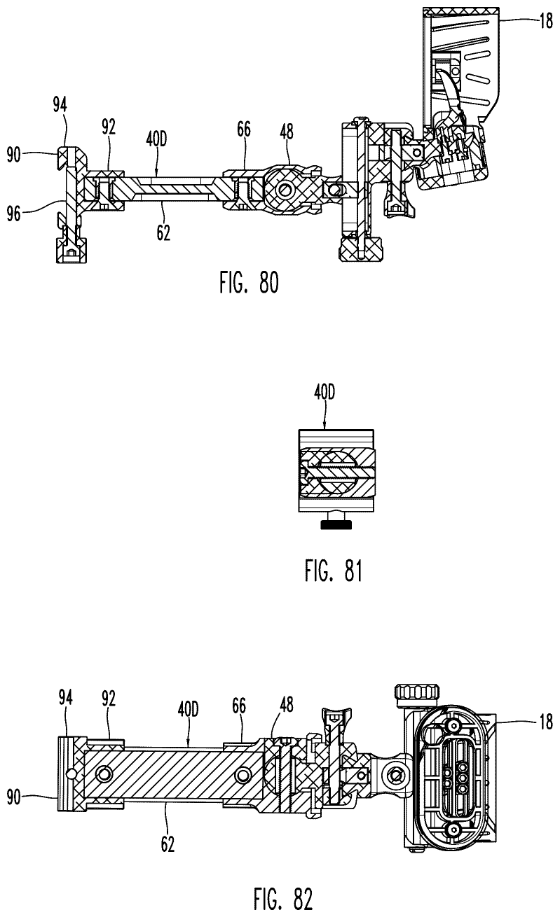

FIGS. 38-82 illustrate non-limiting embodiments of bow sight mounting structures attachable to a bow that each utilizes a ball and socket joint connecting a bow component and a bow sight component capable of allowing relative angular displacement of the bow sight component with respect to the bow component about the three axes of rotation 24, 26, 28 illustrated in FIG. 1 that enables an archer to optically align with the bow about the three axes a bow sight attached to the bow sight component.

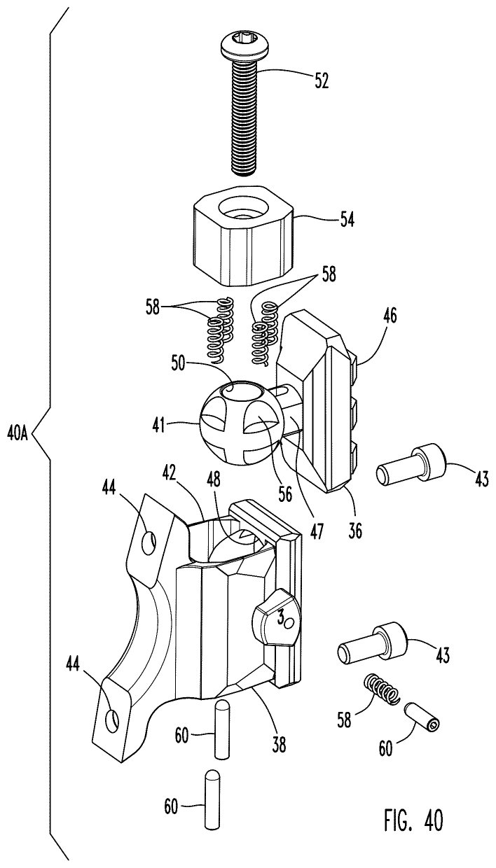

FIGS. 38 and 39 illustrate an embodiment of a bow sight mounting structure 40A of the type shown in FIG. 33 being attached to the riser 10 of a compound bow B. The mounting structure 40A is shown separately in FIGS. 40-47. The bow sight component 36 includes the ball 41 and the bow component 38 includes the socket 42 of the ball and socket joint 34. The bow component 38 is attached to the back of the riser by screws 43 that extend through bow component mounting through-holes 44. The exposed end of the bow sight component 36 is formed as a Picatinny rail 46 similar to the Picatinny rail shown in FIG. 2. The Picatinny rail 46 is connected to the ball 41 by a lever arm 47 that extends through an opening 48 of the socket 42. The ball 41 has an enlarged diametral through hole 50 that receives a threaded fastener 52 extending through a nut 54 nonrotatably held by the socket 42. The nut 54 can be tightened against the ball 41 to fix the ball and socket joint 34. The nut 54 can be loosened to enable angular adjustment of the ball and socket joint 34. The through hole 50 is sized to enable sufficient angular range of motion of the bow sight component 36 about each of the three axes of rotation to achieve optical alignment of an attached bow sight with the bow.

The illustrated bow sight mounting structure 40A enables micro-adjustment of the angular orientation of the ball 41 with respect to the socket 42 about all three axes of rotation. Micro-adjustment enables the archer to mechanically generate fine angular displacement of the ball with respect to the socket selectively about the individual axes of rotation. The ball include recessed pockets 56 that receive springs 58, each spring capable of applying a force to the ball that generates torque urging the ball to rotate with respect to the socket about a respective axis of rotation corresponding to the first, second, and third axes 24, 26, 28 shown in FIG. 1. A respective threaded screw 60 presses against a respective spring 58. The exposed ends of the screws 60 enable the archer to apply a varying force to the springs with screw rotation. Each spring 58 transmits the screw force and variations in force to the ball, causing a small rotation of the ball about the axis of rotation associated with the screw. Each spring 58 can bend along its length to allow rotation of the ball with respect to the socket.

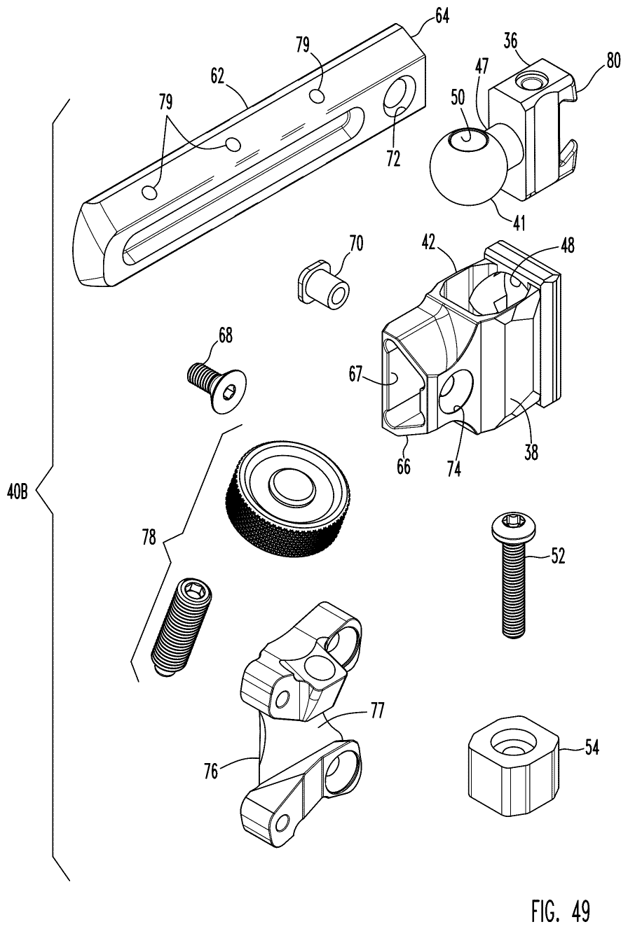

FIGS. 48-53 illustrate an embodiment of a bow sight mounting structure 40B formed as the extension bar 20 shown in FIG. 45. The extension bar 20 has a ball and socket joint 34 located at a an end of the extension bar. The extension bar includes a bar member 62 having a first end 64 being received into a collar 66 forming a first end to the bow component 38 of the ball and socket joint 34. The collar 66 defines an opening 67 that closely and non-rotatably receives the bar end 64. A screw 68 and cooperating threaded sleeve 70 closely pass through aligned through holes 72, 74 formed in the bar member 62 and the collar 66 respectively that releasably fasten together the bar member 62 and the collar 64. The bar member 62 is attached to the bow riser (not shown) via a mounting bracket 76 that receives screws (not shown) threaded into the riser mounting holes 12, 14 shown in FIG. 1. The mounting bracket 76 defines an elongate through-channel 77 that closely receives and extends along the bar member 62. The bar member 62 is selectively positioned along the channel 77 via a threaded screw/handle 78 that is received in spaced apart blind, threaded holes bracket holes 79, enabling the distance that the bow sight component 36 is spaced away from the riser to be selectively set by the archer. The illustrated bow sight component 36 includes a rail grip 80 attached to the ball 46 by a lever arm 81. The lever arm 81 extends from the ball 48 through an opening 82 formed in the socket 48 to the rail grip 80. The rail grip 80 receives and grips a compatible rail of a bow sight (not shown). The ball 46 and the socket 48 construction forming the ball and socket joint 34 is similar to the ball and socket construction shown in FIG. 49 but in the bow sight mounting structure 40B embodiment the ball and socket joint 34 is not configured for micro-adjustments.

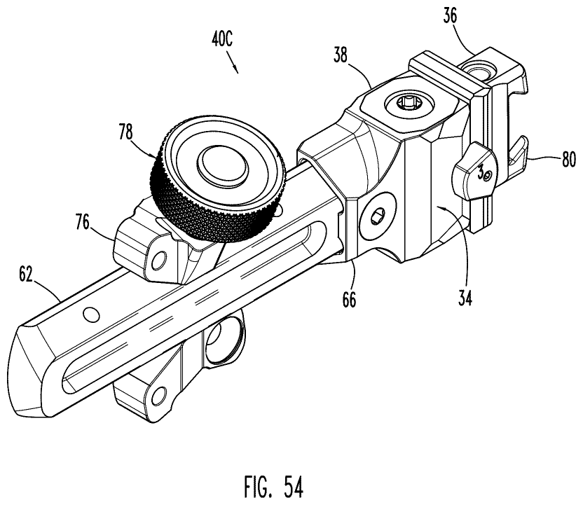

FIGS. 54-61 illustrate a bow sight mounting structure 40C. The bow sight mounting structure 40C is similar to bow sight mounting structure 40B shown in FIGS. 57-62 but differs only in that the ball and socket joint 34 is capable of micro-adjustment as previously described with respect to the bow sight mounting structure 40A shown in FIGS. 49-56.

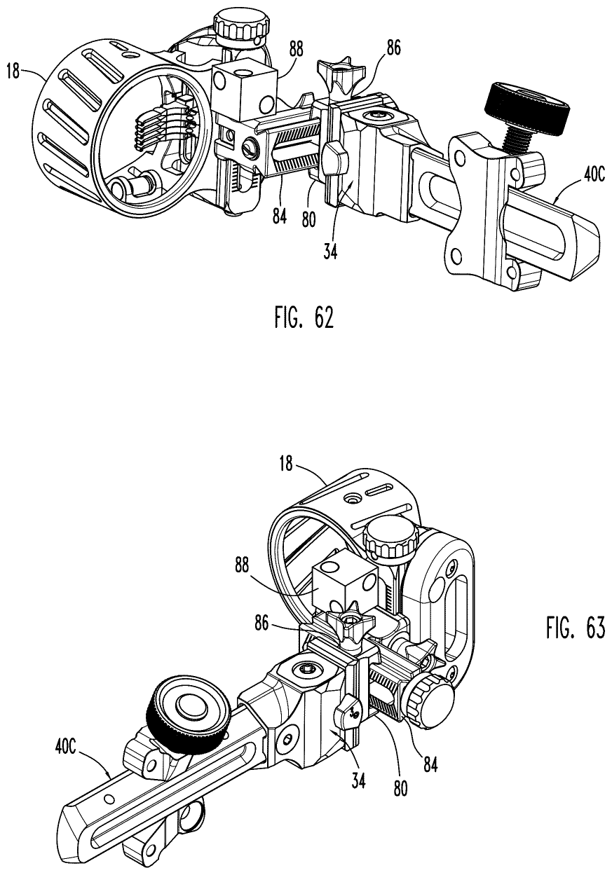

FIGS. 62-72 illustrate the bow sighting mounting structure 40C shown in FIGS. 52-61 wherein the rail grip 80 is fastened to a mounting rail 84 of a bow sight 18. The rail grip 80 includes a threaded rod 86 that extends through the bow site mounting rail 84, enabling selective positioning of the mounting rail 84 along the rail grip 80. The ball and socket joint 34 of the mounting structure 40C enables optical adjustment of the bow sight 18 with respect to the bow (not shown). The bow sight has an attached 3-axis bubble level 88 that is used for adjusting optical alignment of the the bow sight 18 with the bow 10. The 3-axis bubble level 88 may be mounted to the bow sight 18 to replace a bubble level such as the bubble level 22 or the 3-axis bubble level 88 may be used in addition to the bubble level 22 when two-or three-axis optical alignment is desired. The 3-axis bubble level 88 is attached to the bow sight such that the 3-axis bubble level 88 indicates all three of its axes being level when the bow sight is optically aligned with the bow about all three axes of rotation 22, 24, 26 shown in FIG. 1. The 3-axis bubble level 88 may also be attached to other components of the bow sight mounting structure. An externally applied fixed or removable 3-axis bubble level may be attached to the bow sight component 36.

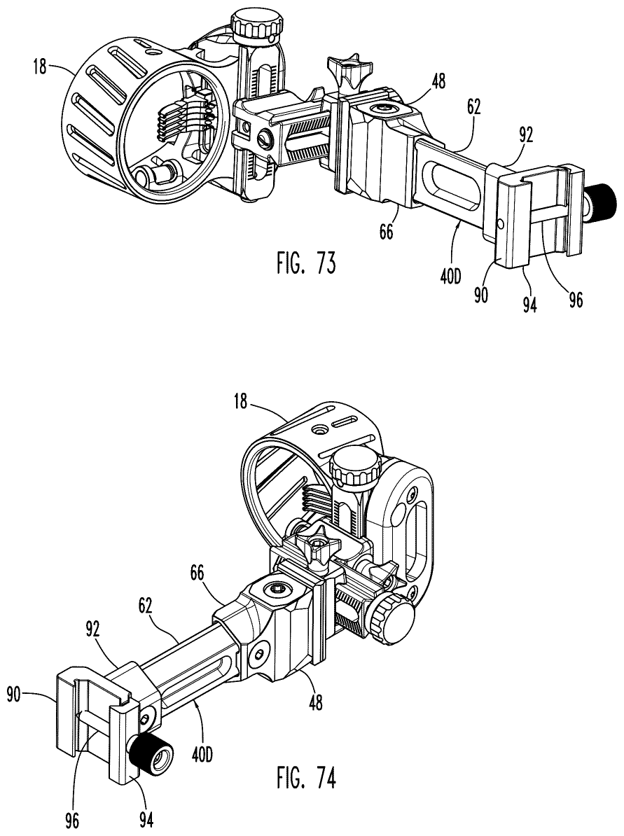

FIGS. 73-82 illustrate a variation 40D of the bow sight mounting structure 40C shown in FIGS. 62-72. The variant mounting structure 40D varies from the mounting structure 40C essentially in having the mounting bracket 76 being removed and the adjacent end 88 of the extension bar member 62 being received in a detachable mounting grip 90 that fastens the extension bar 20 to a back riser mounting rail 16. The mounting grip 90 includes on a first end a collar 92 that receives the end 88 of the extension bar member 62. The collar 92 is similar to the collar 66 of the socket 48 and is releasably attached to the extension bar member 62 in the like manner the collar 66 is attached to the extension bar member 62. The mounting grip 90 includes on the opposite second end a conventional Picatinny two-piece rail grip 94 releasably fastened together by a threaded screw 96. The rail grip 94 is placed over a Picatinny rail such as the rail 16 shown in FIG. 1 to attach the mounting structure 40D to the bow. The rail grip 94 is fastened along along the Picatinny rail by the screw 96. In this embodiment the ball and socket joint 34 is spaced a fixed, predetermined distance from the riser when the rail grip 94 is fastened to the bow.

While this disclosure includes one or more illustrative embodiments, it is understood that the one or more embodiments are each capable of modification and that the scope of this disclosure is not limited to the precise details set forth herein but include such modifications that would be obvious to a person of ordinary skill in the relevant art including (but not limited to) changes in material selection, size, environment of use, ball and socket constructions, fastener constructions that attach the disclosed accessory mounting structure to an implement and to an accessory, and the like.

What is claimed is:

1. An accessory mounting structure for mounting an accessory to a bow comprising a ball and socket joint, the ball and socket joint comprising a bow component being capable of being attached to the bow and an accessory component being capable of being attached to an accessory, the ball and socket joint enabling relative rotation of the accessory component with respect to the bow component about three orthogonal axes of rotation.

2. The accessory mounting structure of claim 1 wherein the ball and socket joint is attached to the bow.

3. The accessory mounting structure of claim 1 wherein the ball and socket joint is attached to a riser of the bow.

4. The accessory mounting structure of claim 1 comprising an extension bar extending along an axis, the extension bar having a pair of axially opposite end portions, the ball and socket joint forming one of the end portions.

5. The accessory mounting structure of claim 1 comprising an extension bar extending along an axis, the extension bar having a pair of axially opposite end portions, the extension bar comprising the ball and socket joint, the ball and socket joint axially spaced away from each of the pair of opposite end portions.

6. The accessory mounting structure of claim 1 wherein one of the bow component and the accessory component of the ball and socket joint is attached to the bow and the other of the bow component and the accessory component is removably fastenable to the one of the bow component and the accessory component.

7. The accessory mounting structure of claim 6 wherein the other of the bow component and the accessory component forms a portion of an extension bar.

8. The accessory mounting structure of claim 6 wherein the other of the bow component and the accessory component is a component of an accessory.

9. The accessory mounting structure of claim 1 wherein the ball and socket joint has micro-adjustment structure operative to mechanically generate fine angular displacement of the ball about at least one of the three axes of rotation.

10. The accessory mounting structure of claim 9 wherein the micro-adjustment structure comprises a plurality of springs and a plurality of recessed surfaces in the ball of the ball and socket joint;
each spring applying a force to a respective recessed surface of the plurality of recessed surfaces, the force urging rotation of the ball with respect to the socket about a respective one of the three axes of rotation.

11. The accessory mounting structure of claim 1 wherein the ball comprises a diametral through-hole and the socket comprises a nut threaded on an elongate threaded member rotatably attached to the socket, the threaded member, extending through the through-hole, the nut non-rotatably connected to the socket, rotation of the threaded member causing displacement of the nut towards or away from the ball.

12. The accessory mounting structure of claim 1 comprising a 3-axis bubble level.

13. The accessory mounting structure of claim 1 comprising a bow sight attached to the accessory structure.

14. The accessory mounting structure of claim 13 comprising a 3-axis bubble level attached to the bow sight.

15. A method for attaching an accessory to an implement comprising the steps of:
connecting a ball of a ball and socket joint to the implement; and
connecting a socket of the ball and socket joint to the accessory,
wherein the accessory is rotatable with respect to the implement about three orthogonal axes extending through a center defined by the ball and socket joint.

16. The method of claim 15 wherein the implement is an archery bow and the accessory is a bow sight, further comprising the step of:
aligning the bow sight about the three axes of rotation and thereby optically aligning the bow sight with the bow.

17. The method of claim 16 wherein the step of aligning the bow sight comprises the step of aligning the bow sight about the three axes of rotation using a 3-axis level fixedly attached to the bow sight.

18. The method of claim 16 comprising the step of:
wherein the step of aligning the bow sight comprises the step of aligning the bow sight about the three axes of rotation using a 3-axis level fixedly attached to a bow sight component of the ball and socket joint.

19. The method of claim 15 comprising the step of:
making micro-adjustments of the ball and socket joint about at least one of the three axes of rotation.

20. The method of claim 19 wherein the step of making micro-adjustments comprises the step of applying a spring force to the ball urging rotation of the ball with respect to the socket about a respective one of the three axes of rotation.
